(19) United States
(12) Patent Application Publication
(10) Pub. No.: US 2015/0267060 A1
(43) Pub. Date: Sep. 24, 2015

(54) HIGHLY DURABLE ANTI-REFLECTIVE COATINGS

(71) Applicant: HONEYWELL INTERNATIONAL INC., Morristown, NJ (US)

(72) Inventors: Sudip Mukhopadhyay, Berkeley, CA (US); Amanuel Gebrebrhan, Mountain View, CA (US); Boris Korolev, San Jose, CA (US); Desaraju Varaprasad, Sunnyvale, CA (US); Ya Qun Liu, Pudong (CN); Yunzi Jiang, Shanghai (CN)

(21) Appl. No.: 14/423,221

(22) PCT Filed: Mar. 5, 2013
(86) PCT No.: PCT/US2013/029001

§ 371 Date: Feb. 23, 2015

Related U.S. Application Data
(60) Provisional application No. 61/695,822, filed on Aug. 31, 2012.
(60) Provisional application No. 61/729,057, filed on Nov. 21, 2012.

(51) Int. Cl. C09D 5/00; C09D 183/04; C08K 3/32; G02B 1/11

(52) U.S. Cl. CPC C09D 5/006; G02B 1/11; C09D 183/04; C08K 3/32; C08K 2003/329

(57) ABSTRACT

A chemically modified anti-reflective (AR) coating is provided having improved durability. The AR coating may be a polymerized alkoxy siloxane-based material that includes a densifier in the form of an organic or inorganic phosphorus (P)-based compound, boron (B)-based compound, antimony (Sb)-based compound, bismuth (Bi)-based compound, lead (Pb)-based compound, arsenic (As)-based compound, or combinations thereof. At least one residue of the densifier may be chemically and/or physically incorporated into the polymerized alkoxy siloxane-based material.

### CROSS-REFERENCE TO RELATED APPLICATIONS

This application is related to U.S. Provisional Patent Application Ser. No. 61/695,822, filed Aug. 31, 2012, and U.S. Provisional Patent Application Ser. No. 61/729,057, filed Nov. 21, 2012, the disclosures of which are hereby expressly incorporated by reference herein in their entirety.

### FIELD OF THE INVENTION

The present disclosure relates generally to anti-reflective (AR) coatings for solar or photovoltaic (PV) cells, and more particularly, to AR coatings having a densifier to improve the durability of the AR coatings.

### DESCRIPTION OF RELATED ART

AR coatings are used in the manufacture of solar or PV cells, modules, and systems to reduce the reflection fraction and increase the transmission fraction of incident light passing through an optically transparent element, such as a glass substrate. As a result, more electricity-producing photons will enter the solar cell. Minimizing the refractive index (RI) of the coating in comparison to that of the substrate may reduce the reflection fraction over a wide range of light wavelengths and a wide range of incident angles. For example, the AR coating on a typical glass substrate may be designed to have a RI between about 1.15 and about 1.3.

While AR coatings may improve the transmission of light through solar cells, AR coatings may be unable to withstand environmental aggressors that come with long-term field performance, such as exposure to ultraviolet (UV) light, rain water, humidity, debris (e.g., hail), and fluctuating temperatures. Thus, AR coatings would benefit from improved durability.

### SUMMARY OF THE INVENTION

The present disclosure provides a chemically modified AR coating having improved durability. The AR coating may be an alkoxy siloxane-based material that includes a densifier in the form of an organic or inorganic phosphorus (P)-based compound, boron (B)-based compound, antimony (Sb)-based compound, bismuth (Bi)-based compound, lead (Pb)-based compound, arsenic (As)-based compound, or combinations thereof. At least one residue of the densifier may be chemically and/or physically incorporated into the polymerized alkoxy siloxane-based material.

According to an embodiment of the present disclosure, an anti-reflective coating solution is provided including a solvent and a polymer. The polymer includes a plurality of Si—O—Si linkages, and at least one densifying element chemically incorporated into the polymer via a Si—O—X linkage, wherein X is the at least one densifying element, the at least one densifying element including at least one element selected from the group consisting of phosphorus, boron, antimony, bismuth, lead, arsenic, and combinations thereof.

According to another embodiment of the present disclosure, a method is provided for producing an anti-reflective coating solution. The method includes: forming a solution of at least one alkoxy silane precursor material and a base catalyst in a solvent; reacting the at least one alkoxy silane precursor material in the presence of the base catalyst to form a polymer matrix in the solvent; reducing the pH of the polymerized solution; and adding a densifier to the solvent, the densifier including a principal densifying element, the principal densifying element of the densifier being incorporated into the polymer matrix. In certain embodiments, said adding step occurs after said reacting step and said reducing step. In other embodiments, said adding step occurs before said reacting step. The method may further include producing an optically transparent element by dispensing the solution onto an optically transparent substrate and curing the solution to form an anti-reflective coating on the optically transparent substrate.

According to yet another embodiment of the present disclosure, an optically transparent element is provided including an optically transparent substrate and an anti-reflective coating disposed on at least one surface of the optically transparent substrate. The anti-reflective coating includes a polymer, and the polymer includes a plurality of Si—O—Si linkages, and at least one densifying element chemically incorporated into the polymer via a Si—O—X linkage, wherein X is the at least one densifying element, the at least one densifying element including at least one element selected from the group consisting of phosphorus, boron, antimony, bismuth, lead, arsenic, and combinations thereof.

### BRIEF DESCRIPTION OF THE DRAWINGS

The above-mentioned and other features and advantages of this disclosure, and the manner of attaining them, will become more apparent and the invention itself will be better understood by reference to the following description of embodiments of the invention taken in conjunction with the accompanying drawings, wherein:

FIG. 1 is a schematic view of a solar cell module including an exemplary AR coating of the present disclosure;

FIG. 2 is a flow chart illustrating a method for producing the AR coating;

FIG. 3 is a portion of a polymer molecule of an exemplary AR coating solution of the present disclosure with certain alkoxy silane residues circled;

FIG. 4 is a schematic view of a salt boil test apparatus for testing the AR coating; and

FIGS. 5 and 6 are experimental Fourier transform infrared spectroscopy (FTIR) spectra.

Corresponding reference characters indicate corresponding parts throughout the several views. The exemplifications set out herein illustrate exemplary embodiments of the invention and such exemplifications are not to be construed as limiting the scope of the invention in any manner.

### DETAILED DESCRIPTION

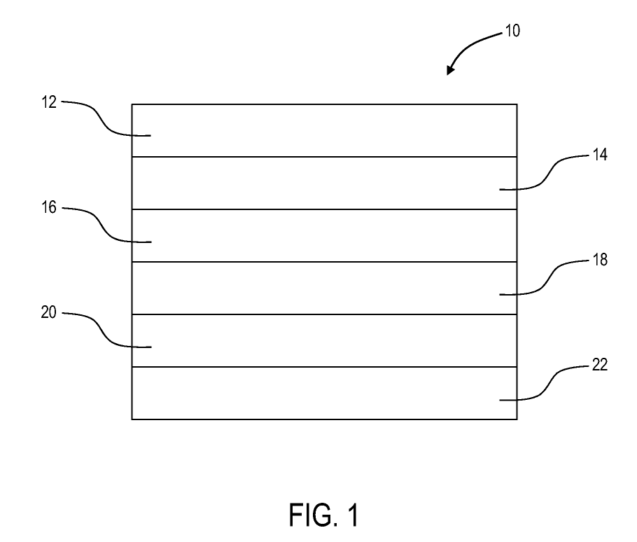

Referring initially to FIG. 1, an exemplary solar or PV cell module 10 is shown schematically. From top to bottom in FIG. 1, module 10 includes an AR coating 12, an optically transparent (e.g., glass) substrate 14, a front transparent electrode 16, a semiconductor or active film 18, an optional reflection enhancement oxide and/or ethylene vinyl acetate (EVA) film 20, and an optional back metallic contact and/or reflector 22. In use, module 10 converts light to electricity. Incident light from the sun or another light source is first incident on AR coating 12, and then the light passes through AR coating 12, through glass substrate 14, and through front transparent electrode 16 before reaching active film 18 of module 10.

AR coating 12 is provided to reduce the reflection fraction and increase the transmission fraction of incident light passing through module 10. More specifically, AR coating 12 is provided to increase the transmission fraction of incident light passing to substrate 14 toward active film 18 of module 10, thereby improving the efficiency of and power output from module 10. Although AR coating 12 is shown and described as being part of module 10, AR coating 12 may have other applications on suitable substrates. AR coating 12 is described further below as an alkoxy silane-based material.

The construction and arrangement of module 10 may differ from the illustrated embodiment of FIG. 1. For example, additional layers not shown in FIG. 1 may be provided in module 10, such as an additional layer between AR coating 12 and glass substrate 14. As another example, a single AR coating 12 may cover multiple solar cells connected in series. Also, module 10 may form part of a larger solar system.

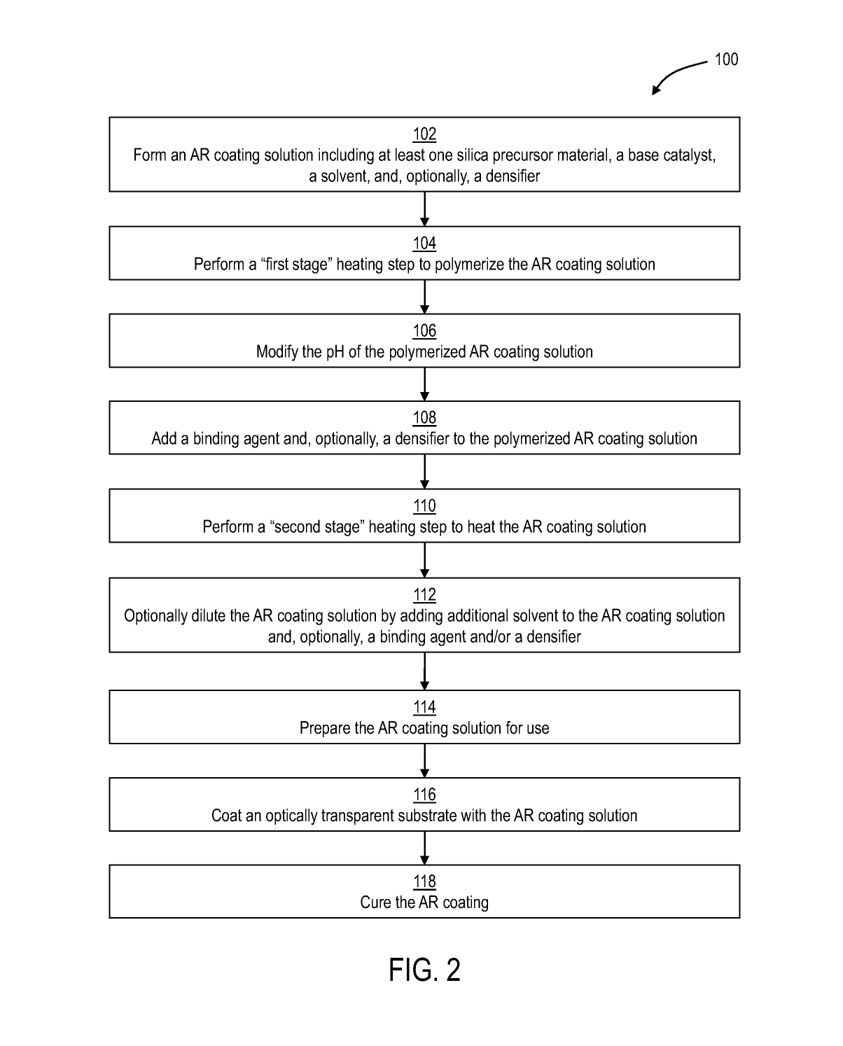

Referring next to FIG. 2, a flow chart is provided to illustrate an exemplary method 100 for forming an AR coating (e.g., AR coating 12 of FIG. 1) on an optically transparent element (e.g., substrate 14 of FIG. 1). Method 100 generally involves polymerizing at least one alkoxy silane precursor material, applying the polymerized material onto the optically transparent element, and curing the polymerized material to form a silicon (Si)-based AR coating on the optically transparent element. An exemplary embodiment of method 100 involves polymerizing at least one alkoxy silane precursor material, and in certain embodiments at least two different alkoxy silane precursor materials, to form the AR coating. The Si-based AR coating includes a plurality of Si—O—Si linkages which are formed from the polymerization of the single or multiple alkoxy silane precursor materials.

Beginning with step 102 of method 100, an AR coating solution is formed by combining at least one silica material with a base catalyst in a solvent. According to an exemplary embodiment of the present disclosure, the AR coating solution includes at least one silica material in the form of an alkoxy silane material, and in certain embodiments, at least two different silica materials in the form of different alkoxy silane materials (i.e., at least a first alkoxy silane material and a second alkoxy silane material). A variety of commercially available alkoxy silane materials may be used to form the AR coating solution.

The initial formation step 102 may also include adding one or more chemical additives to the AR coating solution, which may also be referred to herein as densifiers or densification agents. Suitable types and amounts of densifiers are described further below. If not added during the initial formation step 102, the densifier may be added during a subsequent step. Alternatively, the densifier may be added during both the initial formation step 102 and during a subsequent step.

The ingredients in the AR coating solution may be referred to herein as precursor materials (e.g., a silica precursor material, an alkoxy silane precursor material, a densifier precursor material). The ingredients may be mixed or blended together during the initial formation step 102 to form a homogenous AR coating solution.

Suitable first alkoxy silane materials for use in the AR coating solution of step 102 include, for example, tetraalkoxy silanes, which may include one or more ethoxy, methoxy, and/or propoxy groups as well as hydrogen, methyl, ethyl or propyl groups. In an exemplary embodiment, the first alkoxy silane material is tetraethoxy silane, i.e., tetrathethyl orthosilcate (TEOS). Another suitable first alkoxy silane material is tetramethoxysilane, i.e., tetramethyl orthosilcate (TMOS).

Suitable second alkoxy silane materials for use in the AR coating solution of step 102 include, for example, trialkoxy silanes, such as triethoxy silanes (e.g., methyltriethoxy silane (MTEOS), aminopropyltriethoxy silane (APTEOS), APTEOS-triflate, vinyltriethoxy silane (VTEOS), and diethyl phosphatoethyltriethoxy silane) and trimethoxy silanes (e.g., (3-glycidoxypropyl)-trimethoxy silane). Other suitable second alkoxy silane materials for use in the AR coating solution include dialkoxy silanes (e.g., methyldiethoxy silane (MDEOS), dimethyldiethoxy silane (DMDEOS), and phenyldiethoxy silane (PDEOS)). Still other suitable second alkoxy silane materials for use in the AR coating solution include monoalkoxy silanes. The second alkoxy silane material may be included in the AR coating solution to potentially promote improved coating adhesion and/or other coating properties.

The types of first and second alkoxy silane materials selected for the AR coating solution may vary to achieve desirable coating properties. In one embodiment, the first alkoxy silane material includes TEOS and the second alkoxy silane material includes MTEOS. It is also within the scope of the present disclosure that the second alkoxy silane material may include a combination of different materials to potentially improve coating adhesion and/or coating hardness. In this embodiment, the first alkoxy silane material may include TEOS and the second alkoxy silane material may include a combination of MTEOS and VTEOS, for example.

Also, the amounts of first and second alkoxy silane materials present in the AR coating solution may vary to achieve desirable coating properties. The amount of the first alkoxy silane material may equal or exceed the amount of the second alkoxy silane material in the AR coating solution. For example, the molar ratio of the first alkoxy silane material to the second alkoxy silane material may range from 1:1 to 10:1, more particularly from 1:1 to 3:1, and even more particularly from 1:1 to 2:1. In one embodiment, the second alkoxy silane material comprises as little as about 10 mol %, 15 mol %, 20 mol %, 25 mol %, or 30 mol %, and as much as about 35 mol %, 40 mol %, 45 mol %, or 50 mol % of the total moles of both alkoxy silane materials in the AR coating solution, or may be present within any range defined between any pair of the foregoing values. For example, the second alkoxy silane material may comprise between about 35 mol % and 50 mol % of the total moles of both alkoxy silane materials in the AR coating solution.

Suitable base catalysts for use in the AR coating solution of step 102 include, for example, quaternary amine compounds of the formula R₁R₂R₃R₄N⁺OH⁻, in which R₁, R₂, R₃, and R₄ are each independently hydrogen, an aromatic group, or an aliphatic group. R₁, R₂, R₃, and R₄ may all be the same or may differ from one another. For example, the base catalyst may include a quaternary amine hydroxide, such as tetrabutylammonium hydroxide (TBAH) and tetramethylammonium hydroxide. In some embodiments, the base catalyst includes aqueous solutions of these components, and may optionally include additional distilled water beyond that found in the base catalyst aqueous solutions. With the base catalyst, the AR coating solution may have a basic pH greater than 7.0, such as a pH as low as about 8.0, 8.5, or 9.0, and as high as about 9.5, 10.0, or more, or within any range defined between any pair of the foregoing values, for example.

Suitable solvents or diluents for use in the AR coating solution of step 102 include, for example, water, acetone, isopropyl alcohol (IPA), ethanol, n-propoxypropanol (n-PP), such as dipropylene glycol monomethyl ether (DPGME), propylene glycol, dipropylene glycol, tetraethylene glycol, propylene glycol monomethyl ether (PGME), propylene glycol methyl ether acetate (PGMEA), dimethoxy propanol (DMP), tetrahydrofuran (THF), and ethyl acetate (EA). In some embodiments, the solvent is free of acetone. It is also within the scope of the present disclosure that the solvent may include a combination of different solvents.

Optionally, at least one metal alkoxide other than a silicon alkoxide may also be included in the AR coating solution. If included, suitable metal alkoxides for use in the AR coating solution of step 102 include, for example, metal isopropoxides and metal butoxides. Examples of suitable metal isopropoxides include zirconium isopropoxide and titanium isopropoxide (TIPO). Examples of suitable metal butoxides include hafnium-n-butoxide and zirconium-n-butoxide. In some embodiments, the AR coating solution includes less than 1 mol % metal alkoxide based on the total moles of metal alkoxide and alkoxy silanes.

TIPO may be particularly suitable for improving the hardness of the final AR coating. Additionally, the titanium dioxide derived from TIPO may provide self-cleaning properties to the final AR coating due to the generation of hydroxyl radicals in the presence of water and solar UV light. The hydroxyl radicals may oxidize water-insoluble organic dirt to form highly water-soluble compounds that are washed out during rain. These self-cleaning properties may be optimized according to the amount of TIPO added. In some embodiments, a TIPO content of about 0.0005 moles to about 0.003 moles is exemplary.

Suitable chemical additives or densifiers for use in the AR coating solution of step 102 or a subsequent step include, for example, phosphorus (P)-based compounds, boron (B)-based compounds, antimony (Sb)-based compounds, bismuth (Bi)-based compounds, lead (Pb)-based compounds, arsenic (As)-based compounds, and combinations thereof. The corresponding element P, B, Sb, Bi, Pb, or As of the densifier may be referred to herein as the “principal densifying element.” The densifier may be organic or inorganic in nature. Exemplary densifiers are set forth in Table 1 below.

TABLE 1
Exemplary Densifiers

| Compound | | |
|---|---|---|
| Type | | |
| (Principal | | |
| Densifying | Densifier Precursor Materials | |
| Element) | Organic | Inorganic |
| P | Tris(Trimethylsilylmethyl) | Phosphoric acid |
| | phosphine | (H₃PO₄) |
| | Tris(Trimethylsilyl) | Phosphorus pentoxide |
| | phosphate | (P₂O₅) |
| | Tris(Trimethylsilyl) | Phosphomolybdic acid |
| | phosphite | |
| | | Phosphonoacetic acid |
| | | Metaphosphoric acid |
| | | Phosphorous acid |
| | | (H₃PO₃) |
| | | Phosphorous oxychloride |
| | | Phosphorous pentachloride |
| | | Phosphotungstic acid |
| | | hydrate |
| B | Tris(trimethylsiloxy) boron | Boric acid |
| | | Boron oxides |
| | | Boronic acid |
| | | Boron phosphate |
| | | Boron hydrate |
| Sb | Tris(trimethylsiloxy) | Antimony (III) and (V) oxides |
| | antimony | |
| | Antimonyisopropoxide | Antimony phosphate |
| | Antimony (III) propoxide | |
| Bi | Bismuth (III) salicylate | Bismuth (III) oxides |
| | Bismuth (III) propoxide | Bismuth oxychlorides |
| | | Bismuth (III) phosphate |
| Pb | Lead tetraacetate | Lead oxides |
| | | Lead phosphates |
| | | Lead (II) tetrafluoroborates |
| As | | Arsenic oxides |
| | | Arsenic chlorides |

In certain embodiments, the P-based densifier also contains nitrogen (N). Exemplary N-containing P-based densifiers are represented by Formula (I) below:

CₐH_{b}O_{c}P_{d}NₑCl_{f} (I)

wherein:

a=0-30;

b=0-100;

c=0-10;

d=0-6;

e=0-20; and

f=0-6.

Such densifiers may include other elements in addition to those named in Formula (I), such as iodine (I), boron (B), and fluorine (F), for example. Exemplary N-containing P-based densifiers include phosphazenes and (poly)phosphazenes having N═P bonds. In addition to being bonded to at least one N atom, the P atom of a phosphazene may also be bonded to organic (e.g., alkyl) or inorganic (e.g., OH, halogen) functional groups. Suitable N-containing densifiers are set forth in Table 2 below.

TABLE 2
Exemplary N-Containing Densifiers

| Name | Formula | Structure |
|---|---|---|
| hexachlorocyclotriphosphazene (HCCP) | (NPCl₂)₃ | 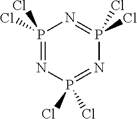 |
| 2-tert-butylamino-1-methyl-2- [tris(dimethylamino)phosphoranylidenamino]- perhydro-1,3,2-diazaphosphorinium iodide | C₁₄H₃₈IN₇P₂ | 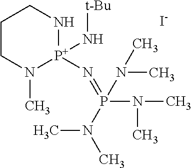 [SMILES: CN(C)P(=N[P+]1(NC(C)(C)C)NCCCN1C)(N(C)C)N(C)C ; [I-]] |
| 2-tert-butylimino-2-diethylamino-1,3- dimethylperhydro-1,3,2-diazaphosphorine | C₁₃H₃₁N₄P | 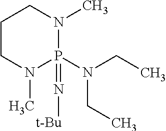 [SMILES: CCN(CC)P1(=NC(C)(C)C)N(C)CCCN1C] |
| 2-tert-butylimino-2-diethylamino-1,3- dimethylperhydro-1,3,2-diazaphosphorine solution 1M in hexane | C₁₃H₃₁N₄P | 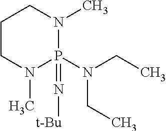 [SMILES: CCN(CC)P1(=NC(C)(C)C)N(C)CCCN1C] |
| 2-tert-butylimino-2-diethylamino-1,3- dimethylperhydro-1,3,2-diazaphosphorine, polymer-bound 200-400 mesh, extent of labeling: 2.0-2.5 mmol/g loading, 1% cross-linked | | 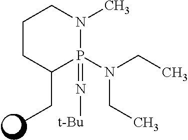 [SMILES: CCC1CCCN(C)P1(=NC(C)(C)C)N(CC)CC] |
| 1,1,1,3,3,3- hexakis(dimethylamino)diphosphazenium tetrafluoroborate | C₁₂H₃₆BF₄N₇P₂ | 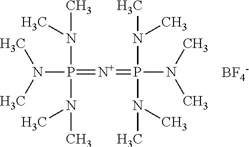 |
| imino-tris(dimethylamino)phosphorane | C₆H₁₉N₄P | 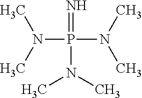 |
| 1,1,3,3,3-pentakis(dimethylamino)-1λ⁵,3λ⁵- diphosphazene 1-oxide | C₁₀H₃₀N₆OP₂ | 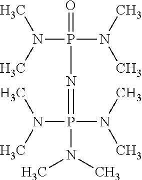 |
| phosphazene base P₁-t-Bu ≧ 97.0% | C₁₀H₂₇N₄P | 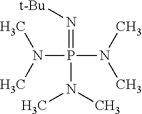 |
| phosphazene base P₂-t-Bu solution ~2.0M in THF | C₁₄H₃₉N₇P₂ | 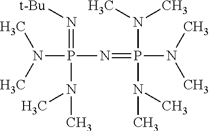 |
| phosphazene base P₂-t-Bu on polystyrene extent of labeling: ~1.6 mmol/g loading | | 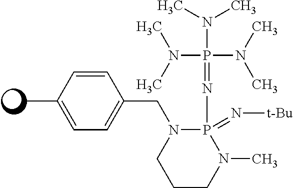 [SMILES: Cc1ccc(CN2CCCN(C)P2(=NC(C)(C)C)N=P(N(C)C)(N(C)C)N(C)C)cc1] |
| phosphazene base P₄-t-Bu solution ~1.0M in hexane | C₂₂H₆₃N₁₃P₄ | 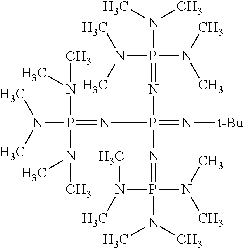 [SMILES: CN(C)P(=NP(=NC(C)(C)C)(N=P(N(C)C)(N(C)C)N(C)C)N=P(N(C)C)(N(C)C)N(C)C)(N(C)C)N(C)C] |
| phosphazene base P₁-t-Bu-tris(tetramethylene) | C₁₆H₃₃N₄P | 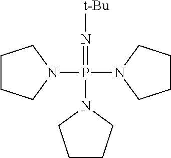 [SMILES: CC(C)(C)N=P(N1CCCC1)(N1CCCC1)N1CCCC1] |
| phosphazene base P₂-Et | C₁₂H₃₅N₇P₂ | 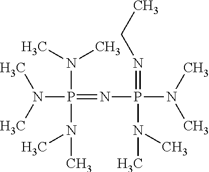 |
| phosphazene base P₁-t-Oct | C₁₄H₃₅N₄P | 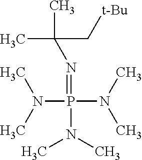 [SMILES: CN(C)P(=NC(C)(C)CC(C)(C)C)(N(C)C)N(C)C] |
| phosphazene base P₄-t-Oct solution 1.00M ± 0.05M in hexane | C₂₆H₇₁N₁₃P₄ | 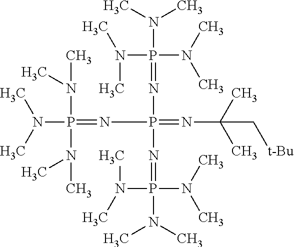 [SMILES: CN(C)P(=NP(=NC(C)(C)CC(C)(C)C)(N=P(N(C)C)(N(C)C)N(C)C)N=P(N(C)C)(N(C)C)N(C)C)(N(C)C)N(C)C] |
| tetrakis[tris(dimethylamino)phosphor- anylidenamino]phosphonium fluoride solution ~0.3M in benzene | C₂₄H₇₂FN₁₆P₅ | 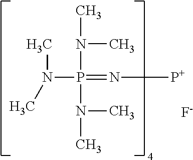 |

The densifier may be added to the AR coating solution in an amount that is sufficient to improve the durability of the final AR coating. Without wishing to be bound by theory, the densifier may improve the durability of the final AR coating by increasing the density (e.g., decreasing the porosity) of the final AR coating. In certain embodiments, the densifier is capable of improving the durability of the final AR coating and may be added to the AR coating solution in an amount as low as about 1 ppm, 10 ppm, 100 ppm, 1,000 ppm, 2,000 ppm, 3,000 ppm, or 4,000 ppm and as high as about 8,000 ppm, 10,000 ppm, 20,000 ppm, 30,000 ppm, 50,000 ppm, or 100,000 ppm, or within any range defined between any pair of the foregoing values, for example. As discussed above, the densifier may be added to the solvent in combination with one or more of the aforementioned alkoxy silanes and/or metal alkoxides to form the AR coating solution.

Referring still to FIG. 2, in step 104 of method 100, the AR coating solution from the initial formation step 102 is heated under suitable reaction conditions to polymerize the alkoxy silane materials present in the AR coating solution. The polymerization step 104 may also be referred to herein as a “first stage” heating step. The polymerization step 104 occurs via a hydrolysis reaction of the first and second alkoxy silane materials in the presence of the base catalyst and an amount of water. A suitable reaction time for the polymerization step 104 may range from about 1 to 6 hours, more particularly about 3.5 to 4.5 hours. A suitable reaction temperature for the polymerization step 104 may range from about 35° C. to 70° C., more particularly about 50° C. to 70° C. The polymerization step 104 may be carried out in a jacketed stirred tank reactor (STR) or another suitable reactor operating in a batch or semi-batch mode, for example.

The initial formation step 102 may be completed before the polymerization step 104. In this embodiment, all of the ingredients may be added to the AR coating solution before directing the AR coating solution to the polymerization step 104. It is also within the scope of the present disclosure that the formation step 102 may at least partially overlap the polymerization step 104. In this embodiment, certain ingredients may be added to the AR coating solution during the polymerization step 104. For example, the densifier and/or the optional metal alkoxide may be added to the AR coating solution during the polymerization step 104.

The resulting polymer matrix from the polymerization step 104 may vary from linear or randomly branched chains to dense colloidal particles. The resulting polymer matrix will include derivatives or residues of the first and second alkoxy silane materials that were added to the AR coating solution during the initial formation step 102. The “residue” of the alkoxy silane material refers to a portion of the polymer molecule which is derived from the corresponding alkoxy silane precursor material in the AR coating solution. For example, TEOS that was added to the AR coating solution during the initial formation step 102 may polymerize to form units of SiO₄ during the polymerization step 104, which would constitute one example of a TEOS residue. In another example, MTEOS that was added to the AR coating solution during the initial formation step 102 may polymerize to form units including a silicon atom bonded to three oxygen atoms and one carbon atom. In this manner, the first and second alkoxy silane materials from the initial formation step 102 may be referred to as precursors of the resulting polymer matrix.

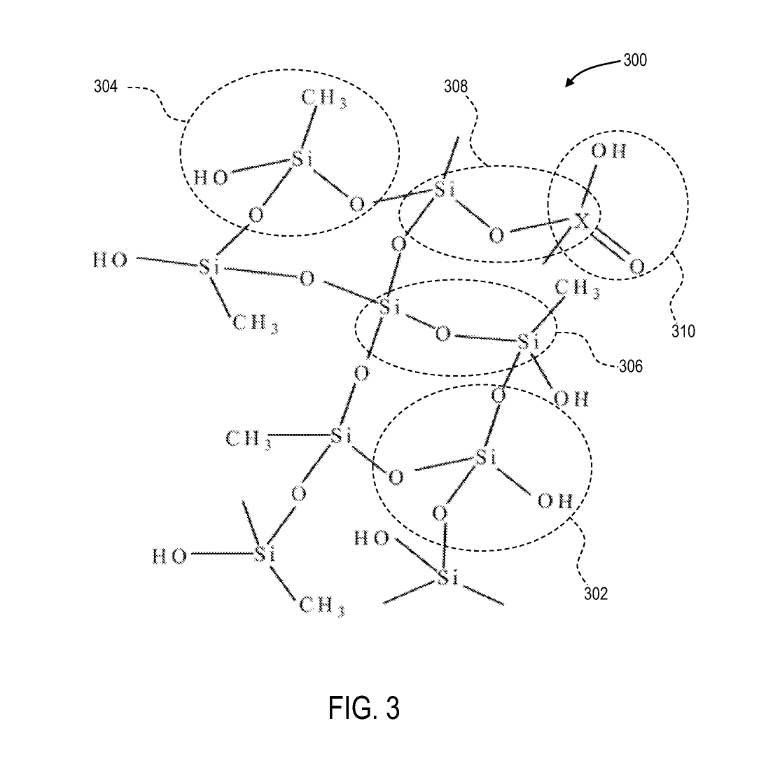

Because the first and second alkoxy silane precursor materials in the AR coating solution may differ from one another, their respective residues in the resulting polymer matrix may also differ from one another. Thus, the resulting polymer matrix may have at least two different alkoxy silane residues (i.e., at least one residue of the first alkoxy silane precursor material and at least one residue of the second alkoxy silane precursor material). In the illustrated embodiment of FIG. 3, for example, a polymer molecule portion 300 is shown with a TEOS residue 302 circled on the bottom-right side of FIG. 3 and a MTEOS residue 304 circled on the top-left side of FIG. 3. The polymer matrix may include additional alkoxy silane residues, such as VTEOS residues. Adjacent residues are bonded together via Si—O—Si linkages, such as Si—O—Si linkage 306 of FIG. 3. In embodiments having only a single alkoxy silane precursor material, such as TEOS, the entire composition of the polymer matrix would be based on a single alkoxy silane residue, in this case the TEOS residue 302. The polymer matrix would lack other alkoxy silane residues, such as the MTEOS residue 304 of FIG. 3.

If the densifier precursor material was added to the AR coating solution before or during the polymerization step 104, the resulting polymer matrix from the polymerization step 104 may also include derivatives or residues of the densifier precursor material from the AR coating solution. The “residue” of the densifier refers to a portion of the polymer molecule which is derived from the corresponding densifier precursor material in the AR coating solution. In this manner, the densifier residues, and more specifically the principal densifying elements (e.g., P, B, Sb, Bi, Pb, or As), may be incorporated directly and chemically into the polymer matrix. Thus, the polymer matrix may include densifier residues in the form of P, B, Sb, Bi, Pb, or As atoms and/or compounds. As used herein, the densifier residue is “chemically incorporated” into the polymer matrix if the densifier residue is chemically bonded to another element of the polymer matrix. In the illustrated embodiment of FIG. 3, for example, the polymer molecule portion 300 includes a densifier residue 310, where X is the principal densifying element.

Even if the densifier residue does not become chemically incorporated into the polymer matrix, some or all of the densifier residue may still become physically incorporated therein, whether in the wet solution stage and/or the cured coating stage. As used herein, the densifier residue is “physically incorporated” into the polymer matrix if the polymer matrix physically retains the densifier residue by a physical interaction other than a chemical bond, such as by physical entrapment of the densifier residue in pores of the polymer matrix, van der Waals forces, or another physical interaction.

In certain embodiments, the chemically incorporated densifier residues may bond to one or more oxygen (O) atoms from adjacent alkoxy silane residues in the polymer matrix to form Si—O—X linkages, where X is the principal densifying element. A Si—O—X linkage 308 is shown in FIG. 3. The number and type of bonds formed to X may vary depending on the valence of X. If the densifier residue is the principal densifying element P, for example, the P atom may bond to one or more O atoms of adjacent alkoxy silane residues to form a Si—O—P linkage. In certain embodiments, the densifier residues may be present as dimers, trimers, and/or oligomers via bonds to one or more O atoms of the same densifier residue or a different densifier residue when more than one densifier is used. It is within the scope of the present disclosure that the densifier residues may bond to other atoms in the polymer matrix instead of or in addition to O atoms. For example, the densifier residues may be chemically bonded to the polymer matrix via hydrogen bonds. Because the amount of the densifier in the AR coating solution may be relatively small compared to other ingredients in the AR coating solution, the densifier residues may make up less than about 10 weight %, 5 weight %, or 1 weight % of the polymer matrix, for example.

The resulting polymer matrix from the polymerization step 104 may further include derivatives or residues of the optional metal alkoxide precursor material from the AR coating solution. In one embodiment, the polymer matrix includes at least one TEOS residue 302 and at least one MTEOS residue 304, as shown in FIG. 3, and additionally includes at least one metal alkoxide (e.g., TIPO) residue (not shown). It is also within the scope of the present disclosure that certain by-products may be formed during the polymerization step 104 and contained either as part of the polymer matrix or as a separate component in the AR coating solution. For example, the hydrolysis of TEOS may result in the formation of ethanol as a by-product.

The resulting polymer matrix may also be represented by Formula (II) below:

—(SiₓH_{y}O_{z})ₘ—(RSiₓH_{y}O_{z})ₙ—(R′XₓH_{y}O_{z})ₒ— (II)

wherein:

(SiₓH_{y}O_{z})ₘ is a first alkoxy silane residue with m repeating units;

(RSiₓH_{y}O_{z})ₙ is a second alkoxy silane residue with n repeating units; and

(R′XₓH_{y}O_{z})ₒ is a densifier residue with o repeating units, where X is the principal densifying element.

When the first alkoxy silane residue (SiₓH_{y}O_{z}) is a TEOS residue, for example, x=1, 0≦y≦3, and z=4. When the second alkoxy silane residue (RSiₓH_{y}O_{z}) is a MTEOS residue, for example, x=1, 0≦y≦2, z=3, and R is CH₃. With respect to the densifier residue (R′XₓH_{y}O_{z}), y=0, 1, or more, depending on if and how many R′ groups are present.

When either m or n=0, the polymer matrix contains only a single type of alkoxy silane residue (e.g., TEOS residues). When m and n are both greater than 0, the polymer matrix contains more than one type of alkoxy silane residue (e.g., both TEOS and MTEOS residues).

In its subsequent cured form, most of the R and R′ groups from Formula (II) may no longer be present. Also, H groups (including silanol groups, Si—OH) and double-bonded O groups may no longer be present. Curing of the polymer matrix is described further below.

In one embodiment, exemplary AR coating solutions are formed without the use of porogens, such as polyethylene glycols or polyethylene oxides, that pyrolize during thermal processing steps to form pores. These types of porogens are also referred to in the art as “structure directing agents”.

Additionally, the AR coating solutions are formed without having to filter the resulting polymer matrix from the reaction solution or to remove components in the solution as required by other reaction methods.

In step 106 of method 100, the pH of the polymerized AR coating solution from the polymerization step 104 is adjusted via acid addition. The pH of the polymerized AR coating solution may be adjusted to less than 7.0, less than 6.0, less than 5.0 or less than 4.0, such as between about 0 and 4.0, more particularly to between about 0 and 2.0, and even more particularly to between about 0.5 and 1.7. A suitable acid includes nitric acid (HNO₃), for example. The acid addition step 106 may occur after the polymerization step 104 has been allowed to proceed for a suitable reaction time, as discussed above.

The acid addition step 106 may diminish or substantially cease further polymerization in the AR coating solution. Thus, the acid addition step 106 may diminish or substantially avoid the formation of additional and larger polymer particles in the AR coating solution, thereby limiting the size of the polymer particles in the AR coating solution and, ultimately, in the final cured coating. The polymer particles may be too small to see with the naked eye and may be evenly suspended throughout the AR coating solution in the form of a sol or a colloidal suspension, giving the polymerized AR coating solution the appearance of a homogenous, transparent liquid. The AR coating solution may also be heterogeneous in nature. In one embodiment, the average particle size of the polymers in the AR coating solution is less than 10 nm, and more particularly less than 5 nm, less than 2 nm, or less than 1 nm, and yet greater than 0 nm. In this respect, as used herein, a “polymer particle” refers to an individual polymer molecule or an aggregate of polymer molecules in a heterogeneous medium or sol, as opposed to a polymer molecule that may be present in a homogeneous medium or sol. After curing, which is discussed further below, the average particle size of the AR coating may be between about 15 and 100 nm, and more particularly between about 25 and 75 nm.

In step 108 of method 100, a binding agent may be added to the polymerized AR coating solution to improve the durability of the final AR coating. By adding the binding agent to the polymerized AR coating solution after the acid addition step 106, the binding agent may interact with the already-formed polymer particles via interfacial bonding between the polymer particles. When the AR coating solution is eventually applied to a substrate and cured, the binding agent may further bind together adjacent polymer particles from the AR coating solution to densify the AR coating. In this manner, the binding agent may serve as a cross-linking agent between adjacent polymer particles. The binding agent may also bind the polymer particles to the underlying substrate to improve interfacial bonding between the AR coating and the substrate.

Increasing the durability of the final AR coating may also increase the RI of the final AR coating. Without a binding agent, the RI of the final AR coating may be about 1.16-1.21. With the binding agent, the RI of the final AR coating may be about 1.22-1.28, which may be preferred for AR coatings on glass substrates.

The binding agent may be in the form of one or more silane materials. Because silane materials are used during both the initial formation step 102 and the binding agent addition step 108, the initial formation step 102 may be referred to herein as the “first stage” of silane addition, and the binding agent addition step 108 may be referred to herein as the “second stage” of silane addition. Suitable silane materials for use as the binding agent include, for example, the aforementioned alkoxy silane materials (e.g., TEOS, TMOS, MTEOS), chloro silane materials, acetoxy silane materials, and combinations thereof. Particularly suitable binding agents include MTEOS and mixtures of MTEOS and TEOS. In embodiments where alkoxy silane materials are used during both the initial formation step 102 and the binding agent addition step 108, the alkoxy silane materials used during the binding agent addition step 108 may be the same as or different from the alkoxy silane materials used during the initial formation step 102.

The type and amount of the binding agent may be selected to improve the durability of the final AR coating, as discussed above. However, the type and amount of the binding agent may vary depending on, for example, the desired viscosity of the AR coating solution, the desired application technique (e.g., spray coating, roller coating), the desired RI of the final AR coating, and other factors. In certain embodiments, the binding agent is added to the AR coating solution in an amount as low as about 5,000 ppm, 10,000 ppm, 15,000 ppm, 20,000 ppm, or 25,000 ppm, and as high as about 30,000 ppm, 35,000 ppm, 40,000 ppm, 45,000 ppm, or 50,000 ppm, or within any range defined between any pair of the foregoing values. An exemplary spray-coating formulation may include between about 40,000 ppm and 50,000 ppm of MTEOS as the binding agent, while an exemplary roller-coating formulation may include between about 5,000 ppm and 15,000 ppm of TEOS as the binding agent, for example.

As discussed above, the densifier precursor material may be added to the AR coating solution during the initial formation step 102. It is also within the scope of the present disclosure to add the densifier precursor material to the AR coating solution along with the binding agent during step 108, as shown in FIG. 2. For example, step 108 may involve adding phosphoric acid (H₃PO₄), hexachlorocyclotriphosphazene (HCCP), and/or another suitable densifier precursor material to the AR coating solution along with a MTEOS and/or TEOS binding agent. It is further within the scope of the present disclosure to add multiple doses of the same or different densifier precursor materials to the AR coating solution—a first dose during the initial formation step 102 and a second dose during the binding agent addition step 108 or a subsequent solvent addition step 112.

Referring next to step 110 of method 100, the AR coating solution is heated under suitable reaction conditions to activate or initiate the cross-linking and binding effects of the binding agent. The heating step 110 may also involve mixing the AR coating solution under suitable reaction conditions. A suitable reaction time for the heating step 110 may range from about 1 to 6 hours, more particularly about 4 hours. A suitable reaction temperature for the heating step 110 may range from about 35° C. to 70° C., more particularly about 50° C. to 60° C. The heating step 110 may be referred to herein as a “second stage” heating step that follows the “first stage” heating of the polymerization step 104. The “second stage” heating step 110 may be conducted at about the same temperature or a lower temperature than the “first stage” polymerization step 104. Like the “first stage” polymerization step 104, the “second stage” heating step 110 may be carried out in a jacketed STR or another suitable reactor operating in a batch or semi-batch mode, for example.

In addition to activating or initiating the binding agent, as described above, the heating step 110 may also trigger chemical and/or physical incorporation of densifier residues from the densifier precursor material. The heating step 110 may cause chemical incorporation of the densifier residues into the polymer matrix, as shown in FIG. 3 and Formula (II) above, and/or physical incorporation of the densifier residues into the polymer matrix. The densifier residues may become incorporated into polymer particles from the polymerization step 104 and/or into cross-linked portions between adjacent polymer particles.

In step 112 of method 100, at least one additional solvent may be added to the polymerized AR coating solution. The AR coating solution may be referred to herein as a “parent” solution before the solvent addition step 112 and as a “child” solution after the solvent addition step 112. The solvent addition step 112 may dilute the “parent” AR coating solution to achieve a desired solids concentration and/or viscosity in the “child” solution for subsequent coating, which is discussed further below. In some embodiments, there may be manufacturing advantages to forming a more concentrated batch in the STR before the polymerization step 104, followed by diluting to a desired concentration during the solvent addition step 112. In alternate embodiments, dilution could occur prior to or during the initial formation step 102, which may render the solvent addition step 112 unnecessary. Suitable solvents are discussed above and include one or more of water, IPA, acetone, and PGMEA, or other high boiling solvents identified above, for example. It is also within the scope of the present disclosure to add additional acid to the AR coating solution during step 112 to maintain a desired pH. It is further within the scope of the present disclosure to add a surfactant to the AR coating solution during step 112.

In the embodiments described above, the densifier and the binding agent are added to the AR coating solution before or during a heating step—the “first stage” polymerization step 104 and/or the “second stage” heating step 110. In another embodiment, the densifier and/or the binding agent may be added to the AR coating solution after the polymerization step 104 and the heating step 110, such as during the solvent addition step 112, as shown in FIG. 2. However, unless the AR coating solution is subjected to additional, post-dilution heating after the solvent addition step 112, which may be referred to herein as a “third stage” heating step, the densifier residue and/or the binding agent may not become chemically incorporated into the polymer matrix of the liquid AR coating solution if added during this late stage. Some or all of the densifier residue and/or the binding agent may still become physically incorporated therein, as described above. Also, when the AR coating solution is ultimately cured, some or all of the densifier residue and/or the binding agent may also become incorporated into the cured AR coating. However, it is believed that chemical and/or physical incorporation into the liquid AR coating solution and cross-linking of the liquid AR coating solution will be more significant when the densifier and/or the binding agent are added to the AR coating solution and then heated in the liquid state, such as during the “first stage” polymerization step 104, the “second stage” heating step 110, and/or a “third stage” post-dilution heating step. When the densifier and/or the binding agent are added without subsequent heating of the liquid AR coating solution before curing, some or all of the densifier and/or the binding agent may be suspended in the solvent of the liquid AR coating solution free from the polymer matrix, for example.

In summary, various ingredients may be combined in various stages to produce AR coating solutions of the present disclosure. Exemplary roller-coating formulations are presented in Table 3 below, and exemplary spray-coating formulations are presented in Table 4 below.

TABLE 3
Exemplary Roller-Coating Formulations (Pre-Cured Solution)

| | Ingredient Amount (grams/Liter) | | | |
|---|---|---|---|---|
| | First Silane | Second Silane | Densifier | Binding Agent |
| | Precursor | Precursor | (e.g., H₃PO₄, | (e.g., MTEOS, |
| Formulation | (e.g., TEOS) | (e.g., MTEOS) | HCCP) | TEOS) |
| Broad Range | 20-80 | 10-30 | 3-15 | 5-30 |
| Intermediate Range | 40-70 | 20-30 | 5-9 | 10-30 |
| Narrow Range | 55-65 | 25-29 | 5-8 | 20-25 |

TABLE 4
Exemplary Spray-Coating Formulations (Pre-Cured Solution)

| | Ingredient Amount (grams/Liter) | | | |
|---|---|---|---|---|
| | First Silane | Second Silane | Densifier | Binding Agent |
| | Precursor | Precursor | (e.g., H₃PO₄, | (e.g., MTEOS, |
| Formulation | (e.g., TEOS) | (e.g., MTEOS) | HCCP) | TEOS) |
| Broad Range | 50-90 | 10-50 | 1-10 | 20-60 |
| Intermediate Range | 65-80 | 30-45 | 2-8 | 30-55 |
| Narrow Range | 70-80 | 35-40 | 4-8 | 35-50 |

In step 114 of method 100, the polymerized AR coating solution may be packaged, transported, stored, or otherwise prepared for later use. For example, the AR coating solution may be packaged in individual flasks, vials, or drums. Unlike other methods of forming AR coating materials, the AR coating solutions of the present disclosure are ready for use without having to remove the polymer particles from solution. Additionally, the AR coating solutions of the present disclosure may remain stable for an extended period of time. The AR coating may be deemed stable if the solution (or its subsequent cured form) maintains desired optical and/or mechanical properties over time, such as transmittance, viscosity, adhesion, and/or pH. At room temperature, AR coating solutions of the present disclosure may remain stable for at least about 24 hours, more particularly about one week, and even more particularly about 4 weeks. Additionally, AR coating solutions of the present disclosure may be stored in a −20° C. to −40° C. freezer for up to at least six months without materially impacting the optical or mechanical properties desired for glass coatings. The ability to preserve AR coatings for an extended period of time may provide a significant manufacturing advantage, particularly if the coating solution is transported to an off-site location and/or stored for a period of time prior to use.

When the polymerized AR coating solution is ready for use, the wet solution is applied or coated onto a surface of an optically transparent substrate in step 116 of method 100. It is also within the scope of the present disclosure to apply the polymerized AR coating solution to more than one surface (e.g., top and bottom surfaces) of the substrate. Suitable substrates include, for example, glass substrates (e.g., sodalime glass, float glass, borosilicate, and low iron sodalime glass), plastic covers, acrylic Fresnel lenses, and other optically transparent substrates. An exemplary glass substrate 14 is shown in module 10 of FIG. 1, for example. The coating step 116 may involve the use of generally known coating techniques, such as spin-on, slot die, spray, dip, roller, and other coating techniques.

Depending on the selected coating technique, the amount of solvent added to the AR coating solution during the initial formation step 102 and/or the solvent addition step 112 may vary such that the solids concentration of the final AR coating solution ranges from about 1 to about 25 weight %. Embodiments of the present disclosure may be particularly suitable for spray-coating and roller-coating applications. The viscosity of the “child” AR coating solution after the solvent addition step 112 may vary from less than about 1 cP to 20 cP or more, and more particularly from about 2 cP to 7 cP, for example.

The type of solvent added to the AR coating solution during the initial formation step 102 and/or the solvent addition step 112 may also vary based on the selected coating technique. For example, low boiling-point solvents (e.g., acetone, IPA) that volatilize at room temperature may be preferred for spray-coating applications, whereas high boiling-point solvents (e.g., propylene glycol, DPM) that are stable at room temperature may be preferred for roller-coating applications.

After applying the AR coating solution onto the optically transparent substrate during the coating step 116, the wet coating is cured during step 118 of method 100. When applied to glass substrates, the curing step 118 may involve subjecting the wet coating to a high temperature ranging from as little as about 200° C. or 300° C. to as high as about 750° C. for between about 1 minute and 1 hour. The curing step 118 may be performed in a belt furnace, such as a gas-fired or coal-fired belt furnace, or another suitable glass tempering furnace. At such high temperatures, the remaining solvent and any other volatile materials in the AR coating solution may vaporize or pyrolize, while the polymer particles in the AR coating solution may join together and to the surface of the substrate to form a hard, cured coating on the substrate. It will be appreciated that the various derivatives or residues of the precursor materials in the initial AR coating solution may be further modified during the curing step 118. However, for purposes of the present disclosure, these materials are still considered derivatives or residues of their corresponding precursor materials.

In certain embodiments, an optional washing step may be performed after the curing step 118 to rinse away any dust, soot, or other particles that were deposited onto the AR coated substrate during the curing step 118. Such particles may be most noticeable when the curing step 118 is performed in a gas-fired or coal-fired belt furnace, in particular. The washing step may involve sending the AR coated substrate through an in-line sprayer or immersing the AR coated substrate in a bath, for example. The solution used to wash the AR coated substrate may have a neutral pH (e.g., water) or a slightly acidic pH between about 4 and 6.

The cured AR coating from the curing step 118 may improve the light transmittance characteristics of the underlying optically transparent substrate. For example, the cured AR coating may have a RI as low as about 1.15, 1.20, or 1.25 and as high as about 1.30 or 1.35, or within any range defined between any pair of the foregoing values. Such RI values may result in up to about a 3% average transmission gain in light wavelengths of 350 to 1,200 nanometers. If both sides of the optically transparent substrate are coated, the cured AR coating may produce up to about a 6% average transmission gain in the same wavelength range. In some embodiments, the absolute gain in transmittance is independent of the coating method used, as long as the thickness of the cured AR coating is tuned to the incident light wavelength (e.g., the cured AR coating thickness is about ¼th the wavelength of the incident light). In the context of solar cells, the transmission gains from the AR coating may improve power outputs by about 2% to 3%, for example.

As discussed above and as demonstrated in the following Examples, the addition of the densifier to the AR coating solution may improve the durability of the final, cured AR coating. In one embodiment, the densifier improves the durability of the AR coating by allowing the AR coating to maintain desired optical properties (e.g., transmittance, RI) when subjected to stress. With the densifier, the optical properties of a stressed AR coating may remain unchanged or may deteriorate by an acceptable amount (e.g., about 1% or less absolute average transmittance loss) relative to an unstressed AR coating. Without the densifier, however, the optical properties of a stressed AR coating may deteriorate by more than the acceptable amount (e.g., more than about 1% absolute average transmittance loss) relative to an unstressed AR coating. The stress test may simulate and/or exaggerate environmental stressors that the AR coating would experience in normal use, such as exposure to UV light, rain water, humidity, debris (e.g., hail), and fluctuating temperatures. The stress test may cause accelerated aging of the AR coating.

The addition of the binding agent to the AR coating solution may also improve the durability of the final, cured AR coating. As with the densifier, the improved durability of the AR coating with the binding agent may be demonstrated through stress tests. It is within the scope of the present disclosure that the densifier and the binding agent may work together to have a cumulative improvement on the durability of the AR coating.

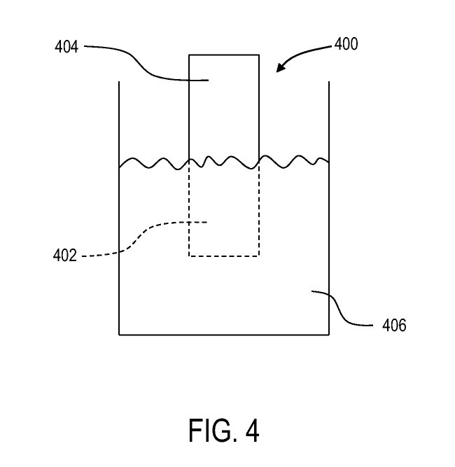

An exemplary stress test includes a salt boil test, the conditions of which are described with reference to FIG. 4. The salt boil test involves immersing the bottom portion 402 of an AR coated sample 400 (shown in phantom) into a boiling salt water solution 406 while leaving the top portion 404 of the AR coated sample 400 (shown in solid lines) exposed outside of solution 406. An exemplary solution 406 includes 2.44 weight % sodium chloride (NaCl) dissolved in distilled water (e.g., 87.82 g NaCl in 3512 g distilled water) that is stirred and heated for about 1 hour until reaching a temperature of 100° C. To ensure consistent results, the NaCl in solution 406 is preferably an ACS reagent grade (>99.0% assay) material, which is commercially available from Sigma-Aldrich Corp. of St. Louis, Mo. The bottom portion 402 of sample 400 is left in solution 406 for a predetermined period of time, such as 2 minutes, 4 minutes, 6 minutes, 8 minutes, 10 minutes, or more. After sample 400 is removed from solution 406, the optical properties of the stressed, bottom portion 402 of sample 400 are measured and compared to the optical properties of the unstressed, top portion 404 of sample 400 to evaluate the impact of the boiling solution 406. When the AR coating on sample 400 is densified according to the present disclosure, the optical properties of the stressed, bottom portion 402 may be the same as or substantially the same as the optical properties of the unstressed, top portion 404, even after relatively long periods of time in the boiling solution 406. For example, the absolute transmittance of the stressed, bottom portion 402 may be within 1%, 0.5%, or less, or even the same as, the absolute transmittance of the unstressed, top portion 404, even after 10 minutes in the boiling solution 406 in some cases.

Other exemplary stress tests are set forth below in Table 5. The AR coatings of the present disclosure may pass one, more than one, or all of the following stress tests by maintaining the same or substantially the same optical properties before and after the stress tests. In certain embodiments, the absolute transmittance of a stressed sample may be within 1%, 0.5%, or less, or even the same as, the absolute transmittance of an unstressed sample. The RI of a stressed sample may also be the same as or substantially the same as the RI of an unstressed sample.

TABLE 5
Exemplary Stress Tests

| Stress | | Available |
|---|---|---|
| Test | Exemplary Conditions | Protocols |
| Abrasion | Exposure to 1,000 cycles of mechanical | EN 1096-2 |
| test | rubbing with felt fingers or pads under a | |
| | load of 400 g (e.g., Crockmeter test) or | |
| | Exposure to 500 cycles of mechanical | |
| | rubbing with a felt pad under a load of | |
| | 500 g | |
| Acid soak | 20 cycles of immersion in 0.67% H₂SO₄ | DIN 50018 |
| test | solution at 40° C. temperature for 2.5 | |
| | minutes per cycle | |
| Base soak | 20 cycles of immersion in 0.67% NaOH | |
| test | solution at 40° C. temperature for 2.5 | |
| | minutes per cycle | |
| Boiling | Submerge in boiling distilled water for 2 | |
| water test | hours | |
| Pressure | Exposure to 121° C. temperature and 2 atm | |
| cooker/steam | pressure at 100% humidity for 24 hours | |
| autoclave | | |
| Salt fog | Exposure to spray (fog) of 5% NaCl salt | ASTM |
| test | solution at temperature of about 25° C. for | B117-09 |
| | 96 hours | IEC 61215 |
| | | DIN 50021 |

Because the densifier and/or the binding agent maintains desired optical properties of the AR coating, the durability improvements with the densifier and/or the binding agent may be recognized without sacrificing optical performance. Without the densifier or the binding agent, the AR coating may improve power outputs by about 2% to 3%. With the densifier and/or the binding agent, the AR coating may have improved durability while still improving power outputs by about 2% to 3%. Additionally, the AR coating may be strongly adhered to the underlying substrate and may be free of visible defects, even after being stressed. Adhesion may be verified by applying tape to the AR coating in a cross-hatch pattern without peel off according to ISO 9211-4, for example.

In another embodiment, the densifier and/or the binding agent improves the durability of the AR coating by improving one or more mechanical or physical properties of the coating. One such mechanical property is the hardness of the AR coating. For example, the hardness of an AR coating with a densifier and/or binding agent may exceed the hardness of an AR coating that lacks a densifier. The hardness of the AR coating may be evaluated using an indentation hardness test (e.g., a Rockwell test) or a scratch hardness test (e.g., Mohs test), for example.

A sample may be subjected to the above-described tests in various forms. For example, a sample may be tested in the form of an AR coating on an optically transparent substrate. A sample may also be tested in the form of an assembled solar cell, solar module, and/or solar system.

### EXAMPLES

### 1. Example 1

### Addition of Phosphorus-Based Densifier to Roller-Coating Formulation in Dilution Stage after “Second Stage” Heating

AR coating solutions were prepared by adding a H₃PO₄ densifier in different amounts ranging from 0 ppm (control) to about 17,000 ppm to a base solution. The base solution comprised a SOLARC®-R AR coating solution that was formulated for roller-coating applications. SOLARC® AR coating solutions are formed of TEOS and MTEOS precursor materials in the manner set forth in US 2010/0313950 to Mukhopadhyay et al., the entire disclosure of which is expressly incorporated herein by reference. SOLARC® AR coating solutions are commercially available from Honeywell Electronic Materials. SOLARC® is a registered trademark of Honeywell International Inc.

The densifier addition occurred during a post-polymerization dilution step (e.g., the solvent addition step 112 of FIG. 2), during which each solution was diluted to a 1.5% solids loading content (expressed in terms of total oxides) by adding a water:DPM solvent and a surfactant while stirring for 30 minutes at room temperature. Each diluted solution was then spin and roller-coated onto a sodalime glass substrate and cured.

The cured samples were subjected to salt boil testing for a predetermined exposure time, as discussed above with reference to FIG. 4. The results are presented in Table 6 below for densifier addition up to about 2,600 ppm.

TABLE 6
Salt Boil Test Results for Example 1

| | | | Exposure | Transmittance (%) | | |
|---|---|---|---|---|---|---|
| Amount | Thickness | | Time | Unstressed | Stressed | |
| (ppm) | (A) | RI | (min) | Portion | Portion | Δ |
| 0 | 1,066 | 1.25 | 3 | 91.98 | 89.78 | −2.20 |
| 909 | 1,054 | 1.26 | 3 | 91.83 | 89.92 | −1.91 |
| 1,304 | 955 | 1.28 | 3 | 92.12 | 90.60 | −1.52 |
| 1,666 | 906 | 1.30 | 3 | 92.08 | 90.96 | −1.12 |
| 2,000 | 832 | 1.31 | 4 | 91.92 | 90.82 | −1.10 |
| 2,307 | 768 | 1.34 | 4 | 92.11 | 91.38 | −0.73 |
| 2,592 | 753 | 1.34 | 4 | 92.01 | 91.70 | −0.31 |

The control sample that lacked the H₃PO₄ densifier suffered a relatively large 2.20% transmittance loss from the salt boil test, and this result occurred after a relatively short period of time (3 minutes). As the amount of the H₃PO₄ densifier increased from 0 ppm to 2,592 ppm, the AR coatings experienced progressively less and less transmittance loss. In fact, the samples made using 2,307 ppm and 2,592 ppm of the densifier experienced transmittance losses less than 1%, even after longer salt boiling periods (4 minutes) than the control (3 minutes). Thus, the H₃PO₄ densifier helped the densified coatings resist the stress of the salt boil test.

### 2. Example 2

### Addition of Phosphorus-Based Densifier and Binding Agent to Roller-Coating Formulation in Formation Before “Second Stage” Heating

AR coating solutions were prepared by adding a H₃PO₄ densifier in different amounts ranging from 0 ppm (control) to about 6,000 ppm to a base solution. Some of the AR coating solutions further included 10,000 ppm of a MTEOS binding agent (Table 8), while other AR coating solutions lacked the binding agent (Table 7).

The base solution comprised a SOLARC®-R AR coating solution that was formulated for roller-coating applications and polymerized. Polymerization was carried out during a “first stage” heating step at 50° C. for 1 to 4 hours. After adding the H₃PO₄ densifier and the MTEOS binding agent, if applicable (e.g., the binding agent addition step 108 of FIG. 2), each solution was subjected to a “second stage” heating step at 50° C. for 4 additional hours (e.g., the heating step 110 of FIG. 2). Each polymerized solution was then diluted to a 1.5% or 0.8% solids loading content by adding water, n-PP or DPM, and a surfactant. Each diluted solution was then spin and roller-coated onto a sodalime glass substrate and cured.

The cured samples were subjected to salt boil testing for a predetermined exposure time. The results are presented in Table 7 and Table 8 below. As indicated above, the solutions of Table 7 lacked a binding agent, while the solutions of Table 8 included a MTEOS binding agent.

TABLE 7
Salt Boil Test Results for Example 2 (without binding agent)

| | | | Exposure | Transmittance (%) | | |
|---|---|---|---|---|---|---|
| Amount | Thickness | | Time | Unstressed | Stressed | |
| (ppm) | (A) | RI | (min) | Portion | Portion | Δ |
| 0 | 1,226 | 1.21 | 3 | 92.78 | 90.09 | −2.69 |
| 1,163 | 1,342 | 1.21 | 3 | 92.93 | 90.14 | −2.79 |
| 2,326 | 1,250 | 1.21 | 3 | 92.77 | 90.38 | −2.39 |
| 3,488 | 1,308 | 1.23 | 3 | 92.63 | 91.01 | −1.62 |
| 4,651 | 1,289 | 1.25 | 3 | 92.67 | 92.11 | −0.56 |

TABLE 8
Salt Boil Test Results for Example 2 (with binding agent)

| | | | Exposure | Transmittance (%) | | |
|---|---|---|---|---|---|---|
| Amount | Thickness | | Time | Unstressed | Stressed | |
| (ppm) | (A) | RI | (min) | Portion | Portion | Δ |
| 0 | 1,306 | 1.22 | 3 | 92.48 | 89.76 | −2.72 |
| 3,488 | 1,498 | 1.23 | 3 | 92.63 | 91.73 | −0.90 |
| 4,651 | 1,429 | 1.25 | 3.5 | 92.60 | 91.64 | −0.96 |
| 5,814 | 1,420 | 1.27 | 4 | 92.58 | 91.85 | −0.73 |

Again, the H₃PO₄ densifier helped the densified coatings resist the stress of the salt boil test, as evidenced by the densified coatings experiencing less transmittance loss after the salt boil test. The MTEOS binding agent further decreased transmittance losses after the salt boil test. For example, with 3,488 ppm of the H₃PO₄ densifier but no MTEOS binding agent, transmittance decreased by 1.62% after the salt boil test (Table 7). By including a MTEOS binding agent along with the same 3,488 ppm of the H₃PO₄ densifier, transmittance decreased by only 0.90% after the salt boil test (Table 8).

### 3. Example 3

### Addition of Phosphorus-Based Densifier to Spray-Coating Formulation in Formation Before “Second Stage” Heating

AR coating solutions were prepared by adding a H₃PO₄ densifier in different amounts ranging from 0 ppm (control) to about 10,000 ppm to a base solution.

The base solution comprised a SOLARC®-S AR coating solution that was formulated for spray-coating applications and polymerized. Polymerization was carried out during a “first stage” heating step at 68° C. for 1 to 4 hours. After adding the H₃PO₄ densifier (e.g., the addition step 108 of FIG. 2), each solution was subjected to a “second stage” heating step at 60° C. for 4 additional hours (e.g., the heating step 110 of FIG. 2). Each polymerized solution was then diluted to a 1% solids loading content by adding water, PGMEA, IPA, and a surfactant. Each diluted solution was then spray-coated onto a sodalime glass substrate and cured.

The cured samples were subjected to salt boil testing for a predetermined exposure time. Again, the H₃PO₄ densifier helped the densified coatings resist the stress of the salt boil test, as evidenced by the densified coatings experiencing less transmittance loss after the salt boil test.

### 4. Example 4

### Densifier Addition in Pre-“Second Stage” Heating Formation Stage Vs. Post-“Second Stage” Heating Dilution Stage

Four different AR coating solutions were prepared, each with a H₃PO₄ densifier. The amount of the densifier added per liter of the parent solution varied from 7,000 to 12,000 ppm. The timing of the densifier addition also varied between an earlier, pre-heating formation stage (e.g., the addition step 108 before the “second stage” heating step 110 of FIG. 2) and a later, post-heating dilution stage (e.g., the solvent addition step 112 of FIG. 2). Each AR coating solution was applied to two substrates to produce duplicative samples.

The cured samples were submerged in water for 48 hours and then dried at 250° C. for 5 minutes. The transmittance and RI of each sample were measured before and after the water submerge test. The results for the two duplicative samples were averaged together. The results are presented in Table 9 below.

TABLE 9
Water Submerge Test Results for Example 4

| | | Thick- | | | | | | |
|---|---|---|---|---|---|---|---|---|
| | Amount | ness | Transmittance (%) | | | RI | | |
| Stage | (ppm) | (A) | Before | After | Δ | Before | After | Δ |
| Form- | 12,000 | 1,260 | 89.9 | 89.9 | 0 | 1.41 | 1.41 | 0 |
| ation | | | | | | | | |
| Dilution | 12,000 | 1,256 | 90.5 | 92.2 | 1.7 | 1.38 | 1.27 | −0.11 |
| Form- | 7,000 | 1,248 | 92.8 | 92.9 | 0.1 | 1.30 | 1.30 | 0 |
| ation | | | | | | | | |
| Dilution | 7,000 | 1,261 | 92.6 | 92.8 | 0.2 | 1.28 | 1.22 | −0.06 |

In samples where the densifier was added during the later, post-heating dilution stage (e.g., the solvent addition step 112 of FIG. 2), the water submerge test impacted RI. This change in RI may be attributed, at least in part, to the densifier leaching out of the polymer matrix during the water submerge test. Such leaching may potentially suggest that the densifier did not chemically incorporate into the polymer matrix and leached out during the water submerge test. For example, the water may have diffused into and through the cured coatings during the water submerge test and leached out the unbound densifier.

In samples where the densifier was added during the earlier, pre-heating formation stage (e.g., the addition step 108 before the “second stage” heating step 110 of FIG. 2), by contrast, the water submerge test did not impact RI. This stability in RI may potentially suggest that the densifier was incorporated directly and chemically and/or physically into the polymer matrix during subsequent heating and retained in the polymer matrix during the water submerge test. In FIG. 3, for example, the densifier residue X is incorporated directly and chemically into the polymer matrix 300 via the Si—O—X linkage 308. Thus, adding the densifier to the AR coating solution before heating the AR coating solution may promote incorporation and long-term retention of the densifier in the polymer matrix during stress tests.

### 5. Example 5

### Addition of Phosphorus-Based Densifier and Binding Agent to Roller-Coating and Spray-Coating Formulations in Formation Before “Second Stage” Heating

AR coating solutions were prepared from either a SOLARC®-R^{PV} AR coating solution formulated for roller-coating applications (Table 10) or a SOLARC®-S^{PV} AR coating solution formulated for spray-coating applications (Table 11). The AR coating solutions were polymerized, diluted, applied to sodalime glass substrates, and cured. During polymerization, the roller-coating formulations were heated for 4.5 hours at 50° C. (Table 10), and the spray-coating formulations were heated for 3.5 hours at 68° C. (Table 11).

After polymerization, some of the AR coating solutions were subjected to binding agent and/or H₃PO₄ densifier addition and additional heating (e.g., the binding agent addition step 108 and the “second stage” heating step 110 of FIG. 2). For the roller-coating formulations, the binding agent comprised TEOS, and the solutions were heated for 4 additional hours at 50° C. (Table 10). For the spray-coating formulations, the binding agent comprised MTEOS, and the solutions were heated for 4 additional hours at 60° C. (Table 11). The remaining, control samples were not exposed to binding agent addition, H₃PO₄ densifier addition, or additional heating after polymerization.

The cured samples were subjected to salt boil testing for a predetermined exposure time. Some of the cured samples were also subjected to abrasion testing, which involved exposing the samples to 500 cycles of mechanical rubbing with a felt pad under a load of 500 g, as described in Table 5 above. The results are presented in Table 10 and Table 11 below.

TABLE 10
Stress Test Results for Example 5 (roller-coating formulations)

| | | | | | Salt Boil Test | | Abrasion Test |
|---|---|---|---|---|---|---|---|
| Densifier | Binder | Parent | | | Exposure | Δ | Δ |
| Amount | Amount | Viscosity | Thickness | | Time | Transmittance | Transmittance |
| (ppm) | (ppm) | (cP) | (A) | RI | (min) | (%) | (%) |
| — | — | 35 | 1,566 | 1.21 | 1 | −0.5 | — |
| — | — | 37 | 1,526 | 1.20 | 1 | −0.6 | — |
| — | — | 39 | 1,532 | 1.21 | 1 | −0.4 | — |
| 5,950 | 10,000 | 39 | 1,612 | 1.28 | 8 | 0.0 | −0.8 |
| 0 | 10,000 | 38 | 1,558 | 1.26 | 8 | −2.4 | −1.6 |
| 5,950 | 0 | 35 | 1,555 | 1.24 | 8 | −2.9 | −1.9 |

TABLE 11
Stress Test Results for Example 5 (spray-coating formulations)

| | | | | | Salt Boil Test | | Abrasion Test |
|---|---|---|---|---|---|---|---|
| Densifier | Binder | Parent | | | Exposure | Δ | Δ |
| Amount | Amount | Viscosity | Thickness | | Time | Transmittance | Transmittance |
| (ppm) | (ppm) | (cP) | (A) | RI | (min) | (%) | (%) |
| — | — | 8 | 1,485 | 1.18 | 3 | −0.4 | — |
| — | — | 9 | 1,501 | 1.20 | 3 | −0.7 | — |
| — | — | 7 | 1,495 | 1.19 | 3 | −0.3 | — |
| 5,950 | 42,000 | 8 | 1,503 | 1.26 | 10 | 0.0 | −0.4 |
| 0 | 42,000 | 7 | 1,525 | 1.26 | 10 | −1.9 | −1.1 |
| 5,950 | 0 | 8 | 1,532 | 1.26 | 10 | −3.0 | −1.5 |

The TEOS and MTEOS binding agents helped the AR coatings resist the stress of the salt boil test over longer exposure times, especially when added in combination with the H₃PO₄ densifier. The AR coatings also resisted the stress of the abrasion test when the TEOS and MTEOS binding agents were added in combination with the H₃PO₄ densifier.

The binding agents and/or the H₃PO₄ densifier also increased the RI of the AR coatings. Without any binding agents or densifiers, the RI of the AR coatings was 1.21 or less. With the binding agent and/or the H₃PO₄ densifier, the RI of the AR coatings was 1.24 or more.

### 6. Example 6

### Addition of Nitrogen-Containing Phosphorus-Based Densifier to Roller-Coating Formulation in Dilution Stage after “Second Stage” Heating

AR coating solutions were prepared by adding a nitrogen-containing phosphorus-based densifier, specifically hexachlorocyclotriphosphazene (HCCP), in different amounts ranging from 0 ppm (control) to about 3,000 ppm to a base solution. As described further below, the base solution also contained a H₃PO₄ densifier and a TEOS binding agent.

The base solution comprised a SOLARC®-R AR coating solution that was formulated for roller-coating applications and polymerized. Polymerization was carried out during a “first stage” heating step at 50° C. for 1 to 4 hours. After polymerization, about 6,000 ppm of the H₃PO₄ densifier and about 10,000 ppm of the TEOS binding agent were added per liter of solution (e.g., the binding agent addition step 108 of FIG. 2), and then each solution was subjected to a “second stage” heating step at 50° C. for 4 additional hours (e.g., the heating step 110 of FIG. 2). Each solution was then diluted to 1.5% solids loading content by adding water, n-PP or DPM, and a surfactant.

Each diluted solution was then divided into three parts—Part A (control), Part B, and Part C. About 3,000 ppm of the HCCP densifier was added and thoroughly mixed into the Part B and Part C solutions, while the Part A solution was left as is to serve as the control. The Part A and Part B solutions were kept at room temperature, while the Part C solution was subjected to additional, post-dilution heating at 60° C. for 16 hours. The post-dilution heating of the Part C solution followed the “first stage” heating and the “second stage” heating of the solution, and as such, the post-dilution heating may be referred to herein as a “third stage” heating step. Each coating solution was then spin-coated onto a sodalime glass substrate and cured.

The cured samples were subjected to salt boil testing for a predetermined exposure time. The results are presented in Table 12 below.

TABLE 12
Salt Boil Test Results for Example 6

| | Densifiers | | | | Transmittance (%) | | |
|---|---|---|---|---|---|---|---|
| | H₃PO₄ | HCCP | Post-Dilution | Exposure Time | Unstressed | Stressed | |
| Part | (ppm) | (ppm) | Heating | (min) | Portion | Portion | Δ |
| A | 5,950 | 0 | N | 10 | 94.4 | 93.9 | −0.5 |
| B | 5,950 | 3,000 | N | 10 | 93.9 | 94.4 | 0.5 |
| C | 5,950 | 3,000 | Y | 10 | 94.1 | 94.1 | 0.0 |
| A | 5,950 | 0 | N | 20 | 94.4 | 93.6 | −0.8 |
| B | 5,950 | 3,000 | N | 20 | 93.9 | 94.4 | 0.5 |
| C | 5,950 | 3,000 | Y | 20 | 94.1 | 94.0 | −0.1 |

A separate set of cured samples were exposed to a salt fog testing, as described in Table 5 above. The results are presented in Table 13 below.

TABLE 13
Salt-Fog Test Results for Example 6

| | Densifiers | | | | Transmittance (%) | | |
|---|---|---|---|---|---|---|---|
| | H₃PO₄ | HCCP | Post-Dilution | Exposure Time | Unstressed | Stressed | |
| Part | (ppm) | (ppm) | Heating | (hr) | Portion | Portion | Δ |
| A | 5,950 | 0 | N | 96 | 94.2 | 93.6 | −0.6 |
| B | 5,950 | 3,000 | N | 96 | 94.3 | 94.3 | 0.0 |
| C | 5,950 | 3,000 | Y | 96 | 94.5 | 94.5 | 0.0 |

A separate set of cured samples were exposed to abrasion testing, as described in Table 5 above. The results are presented in Table 14 below.

TABLE 14
Abrasion Test Results for Example 6

| | |
|---|---|
| Densifiers | Post- |

| | H₃PO₄ | HCCP | Dilution | Δ |
|---|---|---|---|---|
| Part | (ppm) | (ppm) | Heating | Transmittance (%) |
| A | 5,950 | 0 | N | −0.8 |
| B | 5,950 | 3,000 | N | −0.6 |
| C | 5,950 | 3,000 | Y | −0.5 |

The additional HCCP densifier helped the cured coatings resist the stress of the salt boil test (Table 12), the salt-fog test (Table 13), and the abrasion test (Table 14), as evidenced by the cured coatings made with the HCCP densifier (Parts B and C) experiencing less transmittance loss after the stress tests than the cured coatings made without the HCCP densifier (Part A). Also, heating the solutions after adding of the HCCP densifier (Part C) helped the cured coatings withstand the stress tests. Without wishing to be bound by theory, this post-dilution heating step may promote incorporation and long-term retention of the HCCP densifier in the polymer matrix during stress tests.

The cured coatings were also subjected to pencil hardness testing. The cured coatings made from solutions that lacked the HCCP densifier (Part A) had a hardness of 5H. The cured coatings made from solutions that included the HCCP densifier but without post-dilution heating (Part B) had a lower hardness of 3H. The cured coatings made from solutions that included the HCCP densifier with post-dilution heating (Part C) returned to a hardness of 5H, like the coatings made from the Part A solutions. These results suggest that post-dilution heating after densifier addition maintains or improves coating hardness, in addition to helping the cured coatings withstand the stress tests.

### 7. Example 7

### Incorporation of Phosphorus-Based Densifier into Cured Coatings

AR coating solutions were prepared with H₃PO₄ densifiers. A first AR coating solution (Sample A) was not subjected to “second stage” heating after the H₃PO₄ addition, while a second AR coating solution (Sample B) was subjected to “second stage” heating after the H₃PO₄ addition. The AR coating solutions were applied to glass substrates and cured.

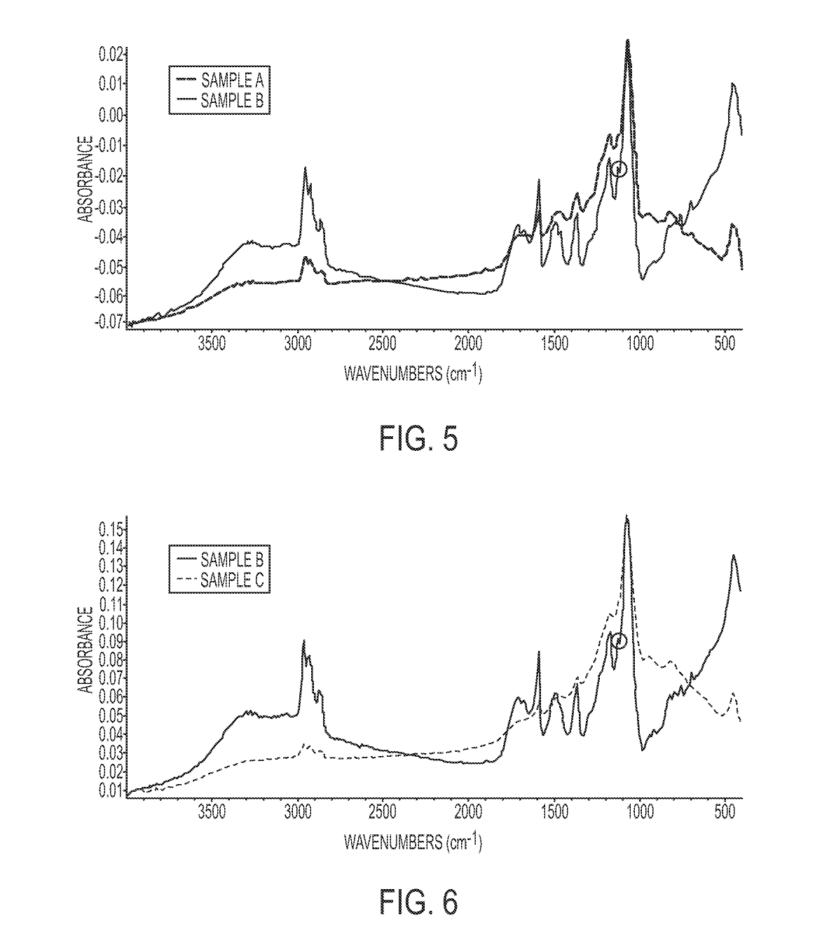

The cured coatings were then subjected to Fourier transform infrared spectroscopy (FTIR), the results of which are shown in FIG. 5. Unlike the cured coatings produced from Sample A, the cured coatings produced from Sample B included a new peak at 1,125 cm⁻¹ wavenumbers (circled in FIG. 5). Because Si—O bonds appear at 1,050 cm⁻¹ and P—O bonds appear at 1,325 cm⁻¹, the new peak appearing therebetween at 1,125 cm⁻¹ is believed to evidence a P-bond within the cured Si—O matrix (e.g., Si—O—P). Thus, “second stage” heating promotes P-incorporation.

To support the results of FIG. 5, a third AR coating solution (Sample C) was prepared without an H₃PO₄ denisfier. The AR coating solutions were applied to glass substrates and cured.

The cured coatings were then subjected to FTIR, the results of which are shown in FIG. 6. The cured coatings produced from the H₃PO₄-containing solution (Sample B) included the same peak at 1,125 cm⁻¹ wavenumbers (circled in FIG. 6). As anticipated, the cured coatings produced from the H₃PO₄-free solution (Sample C) lacked a peak at 1,125 cm⁻¹ wavenumbers, which supports the absence of a P-bond within the cured Si—O matrix.

Without wishing to be bound by theory, it is thought that the P-incorporation seen in cured Sample B of FIGS. 5 and 6 makes the cured coatings more robust to withstand durability testing.

### 8. Comparative Example 8

### Addition of Phosphorus-Based Compounds to Colloidal Silica

AR coating solutions were prepared by adding a P-based compound selected from P₂O₅ and H₃PO₄ to IPA-ST type colloidal silica particles, which is available from Nissan Chemical America Corporation of Houston, Tex. Each highly acidic solution was left overnight under stirring and then for 5 days. The AR coating solutions were applied to glass substrates and cured.

The cured coatings were then subjected to FTIR. Although P-based compounds were added in the solution state, the cured coatings lacked a peak at 1,125 cm⁻¹ wavenumbers, which indicates that the P-based compounds did not incorporate into the coatings in the cured state. Without wishing to be bound by theory, the lack of active silanol groups on the hard, solid, colloidal silica particles of these AR coating solutions may prevent such P-incorporation, whether in the solution state or in the cured state.

The cured coatings of Example 8 were also subjected to durability testing. However, the cured coatings deteriorated completely after 10 minutes of salt boil testing and 500 strokes of abrasion testing. The cured coatings were also easily removed from the glass substrates when scratched or rubbed with a finger nail.

### 9. Example 9

### Addition of Antimony-Based and Bismuth-Based Densifiers to Roller-Coating Formulation

AR coating solutions were prepared by adding either a SbCl₃ densifier (Sample B) or a Bi-salt densifier (Samples C and D) to a base solution comprising a SOLARC®-R AR coating solution. Additional AR coating solutions were prepared by adding a SbCl₃ densifier and an H₃PO₄ densifier, in combination, to the SOLARC®-R base solution (Samples E-G). The SOLARC®-R base solution was also used as a control sample without any densifiers (Sample A). Each coating solution was coated onto a glass substrate and cured.

The cured samples were subjected to salt boil testing for a predetermined exposure time and abrasion testing. The results are presented in Table 15 below.

TABLE 15
Stress Test Results for Example 9

| | Densifiers | | | | Δ Transmittance (%) | | |
|---|---|---|---|---|---|---|---|
| | SbCl₃ | Bi-salt | H₃PO₄ | | Salt Boil Test | Salt Boil Test | Abrasion |
| Sample | (ppm) | (ppm) | (ppm) | RI | (1 min) | (3 min) | Test |
| A | 0 | 0 | 0 | 1.26-1.28 | −2.14 | −2.75 | −0.91 |
| B | 247,000 | 0 | 0 | 1.31-1.33 | 0.90 | 0.60 | −0.83 |
| C | 0 | 49,000 | 0 | 1.28-1.29 | 0 | N/A | −1.06 |
| D | 0 | 94,000 | 0 | 1.35-1.36 | 0.28 | N/A | −1.12 |
| E | 50,000 | 0 | 6,000 | 1.41-1.43 | 1.09 | 2.19 | −2.02 |
| F | 45,000 | 0 | 5,000 | 1.36-1.37(*) | 1.76 | 1.76 | −0.94 |
| G | 40,000 | 0 | 5,500 | 1.36-1.38(*) | 0.36 | 1.17 | −1.04 |

(*)Estimated based on transmittance values.

The Sb-based and Bi-based densifiers helped the cured coatings resist the stress of the salt boil tests, as evidenced by the densifier-containing coatings (Samples B-G) experiencing less transmittance loss after the salt boil tests than the densifier-free, control coating (Sample A). The SbCl₃-containing coatings (Samples B and E-G), in particular, were able to withstand 3 minutes of salt boil testing.

The Sb-based and Bi-based densifiers did not significantly impact the performance of the cured coatings in the abrasion test.

While this invention has been described as having exemplary designs, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. An anti-reflective coating solution comprising:
a solvent; and
a polymer comprising:
a plurality of Si—O—Si linkages; and
at least one densifying element chemically incorporated into the polymer via a Si—O—X linkage, wherein X is the at least one densifying element, the at least one densifying element comprising at least one element selected from the group consisting of phosphorus, boron, antimony, bismuth, lead, arsenic, and combinations thereof.

2. The anti-reflective coating solution of claim 1, wherein the at least one densifying element is also physically incorporated into the polymer.

3. The anti-reflective coating solution of claim 1, wherein the polymer further comprises at least one residue of a first alkoxy silane precursor material.

4. The anti-reflective coating solution of claim 3, wherein the first alkoxy silane precursor material comprises tetraethoxy silane.

5. The anti-reflective coating solution of claim 3, wherein the polymer further comprises a residue of a second alkoxy silane precursor material different from the first alkoxy silane precursor material.

6. The anti-reflective coating solution of claim 5, wherein the second alkoxy silane precursor material is selected from the group consisting of: trialkoxy silanes, dialkoxy silanes, monoalkoxy silanes, and combinations thereof.

7. The anti-reflective coating solution of claim 1, wherein the densifying element is a residue of a densifier in the anti-reflective coating solution.

8. The anti-reflective coating solution of claim 7, wherein the densifier is selected from the group consisting of: a phosphorus-based compound, a boron-based compound, an antimony-based compound, a bismuth-based compound, a lead-based compound, an arsenic-based compound, and combinations thereof.

9. The anti-reflective coating solution of claim 8, wherein the densifier comprises phosphoric acid.

10-13. (canceled)

14. A method of producing an anti-reflective coating solution comprising:
forming a solution of at least one alkoxy silane precursor material and a base catalyst in a solvent;
reacting the at least one alkoxy silane precursor material in the presence of the base catalyst to form a polymer matrix in the solvent;
reducing the pH of the polymerized solution; and
adding a densifier to the solvent, the densifier including a principal densifying element, the principal densifying element of the densifier being incorporated into the polymer matrix.

15. The method of claim 14, wherein the principal densifying element of the densifier is at least one of chemically incorporated and physically incorporated into the polymer matrix.

16. The method of claim 14, wherein the densifier is selected from the group consisting of: a phosphorus-based compound, a boron-based compound, an antimony-based compound, a bismuth-based compound, a lead-based compound, an arsenic-based compound, and combinations thereof.

17. The method of claim 16, wherein the principal densifying element of the densifier comprises at least one element selected from the group consisting of phosphorus, boron, antimony, bismuth, lead, arsenic, and combinations thereof.

18. The method of claim 14, wherein the solution comprises between about 1 ppm and 100,000 ppm of the densifier.

19. (canceled)

20. The method of claim 14, wherein said adding step occurs after said reacting step and said reducing step.

21. The method of claim 20, further comprising a heating step after said adding step, said heating step incorporating the principal densifying element of the densifier into the polymer matrix.

22. The method of claim 14, wherein said adding step occurs before said reacting step, said reacting step incorporating the principal densifying element of the densifier into the polymer matrix.

23. (canceled)

24. (canceled)

25. An optically transparent element comprising:
an optically transparent substrate; and
an anti-reflective coating disposed on at least one surface of the optically transparent substrate, the anti-reflective coating comprising a polymer, the polymer comprising:
a plurality of Si—O—Si linkages; and
at least one densifying element chemically incorporated into the polymer via a Si—O—X linkage, wherein X is the at least one densifying element, the at least one densifying element comprising at least one element selected from the group consisting of phosphorus, boron, antimony, bismuth, lead, arsenic, and combinations thereof.

26. The optically transparent element of claim 25, wherein the at least one densifying element is also physically incorporated into the polymer.

27. The optically transparent element of claim 25, wherein the anti-reflective coating has a reflective index of about 1.15 to 1.35.

28-30. (canceled)
